(19) United States
(12) Patent Application Publication
(10) Pub. No.: US 2017/0206511 A1
(43) Pub. Date: Jul. 20, 2017

(54) SYSTEM AND METHOD FOR DISTRIBUTED INFORMATION PROCESSING

(71) Applicant: TOSHIBA TEC KABUSHIKI KAISHA, Tokyo (JP)

(72) Inventors: Yumiko OOKUMA, Nakano Tokyo (JP); Masanori SANBE, Mishima Shizuoka (JP)

(21) Appl. No.: 15/406,456

(22) Filed: Jan. 13, 2017

(30) Foreign Application Priority Data
Jan. 15, 2016 (JP) 2016-005706

(51) Int. Cl. G06Q 20/04; G06Q 20/20; G06Q 30/06; H04L 29/08

(52) U.S. Cl. CPC G06Q 20/0453; H04L 67/02; G06Q 20/202; G06Q 30/0631; H04W 88/02

(57) ABSTRACT

A distributed information processing system includes point-of-sale (POS) terminals configured to collect data, a first server communicating with the POS terminals over a private network to aggregate data collected by the POS terminals, a second server communicating with the first server over a public network to centrally store the aggregated data from the first server and other servers that aggregate data collected by POS terminals, a third server communicating with the second server over the public network to generate specialized content based on data stored by the second server, and a portable terminal of a user registered with the second server. The portable terminal simultaneously displays a first image representative of a piece of data stored by the second server for the user and a second image representative of the specialized content generated by the third server based on data stored by the second server for the user.

### CROSS-REFERENCE TO RELATED APPLICATION

This application is based upon and claims the benefit of priority from Japanese Patent Application No. 2016-005706, filed Jan. 15, 2016, the entire contents of which are incorporated herein by reference.

### FIELD

Embodiments described herein relate generally to system and method for distributed information processing.

### BACKGROUND

In the related art, an electronic receipt system displays electronic receipt information digitized from receipt information related to sales registration of merchandise on a display terminal such as a portable terminal, and enables customers to browse the electronic receipt information.

Since consumption of receipt sheets can be reduced by reducing printing of the receipt information, it is also beneficial to introduce the electronic receipt system to stores.

However, the electronic receipt system in the related art merely enables customers to browse the electronic receipt information. It would be desirable to further utilize the electronic receipt information.

### DESCRIPTION OF THE DRAWINGS

FIG. 1 is a configuration diagram illustrating an overall configuration of an electronic receipt system according to an embodiment.

FIG. 2 is a block diagram illustrating a hardware configuration of a POS terminal.

FIG. 3 is a block diagram illustrating a hardware configuration of an electronic receipt management server.

FIG. 4 is a memory map illustrating an electronic receipt information unit of the electronic receipt management server.

FIG. 5 is a block diagram illustrating a hardware configuration of a portable terminal.

FIG. 6 is a flowchart illustrating a control process in the POS terminal.

FIG. 7 is a functional block diagram illustrating a functional configuration of the electronic receipt management server.

FIG. 8 is a flowchart illustrating a control process in the electronic receipt management server.

FIG. 9 is a flowchart illustrating a control process in the portable terminal.

FIG. 10 is a diagram illustrating a display example of an association electronic receipt displayed on the portable terminal.

### DETAILED DESCRIPTION

Embodiments provide an information processing apparatus that enables customers to browse an “association electronic receipt information.” As used herein, the “association electronic receipt information” includes electronic receipt information related to merchandise purchased by a customer and in addition associated information such as information related to merchandise that is recommended (i.e., recommendation merchandise) based on the purchased merchandise.

In general, according to an embodiment, A distributed information processing system includes a plurality of point-of-sale (POS) terminals configured to collect data, a first server communicating with the POS terminal over a private network to aggregate data collected by the POS terminals, a second server communicating with the first server over a public network to centrally store the aggregated data from the first server and other servers that aggregate data collected by POS terminals, a third server communicating with the second server over the public network to generate specialized content based on data stored by the second server, and a portable terminal of a user registered with the second server. The portable terminal is configured to simultaneously display on a display unit thereof a first image representative of a piece of data stored by the second server for the user and a second image representative of the specialized content generated by the third server based on data stored by the second server for the user.

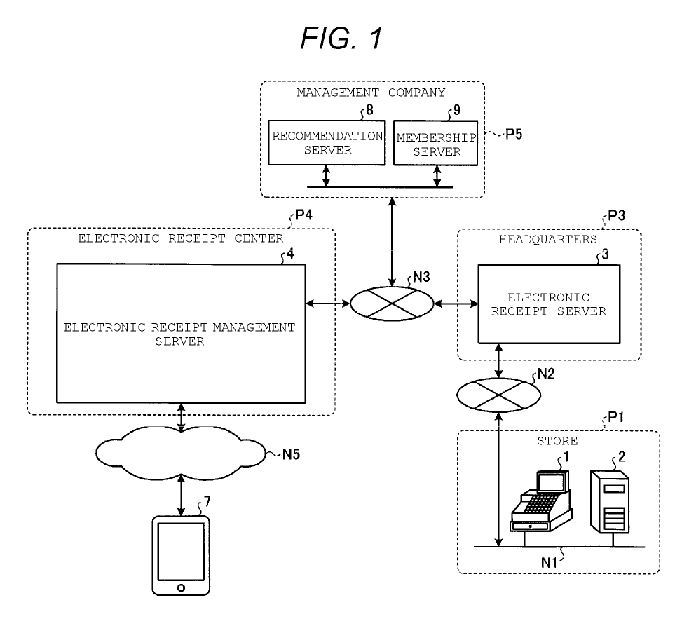

Hereinafter, with reference to diagrams of FIG. 1 to FIG. 10, an information processing apparatus related to an embodiment will be described. In the embodiment, an electronic receipt management server will be described as an example of the information processing apparatus. In addition, a portable terminal will be described as an example of a display device. The invention is not limited by the embodiment which will be described below.

FIG. 1 is a configuration diagram illustrating an overall configuration of an electronic receipt system related to the embodiment. As illustrated in FIG. 1, the electronic receipt system includes a point of sales (POS) terminal 1, a store server 2, an electronic receipt server 3, an electronic receipt management server 4, a portable terminal 7, a recommendation server 8, and a member server 9.

The POS terminal 1 and the store server 2 are provided within a store P1. The POS terminal 1 and the store server 2 are communicatively connected to each other through a network N1 within the store such as a local area network (LAN). In addition, the POS terminal 1 and the store server 2 can be connected to a network N2 connecting the store P1 and a headquarters P3 through a network device (not illustrated) such as a router connected to the network N1 within the store. Here, for example, the network N2 is a leased line such as the Internet and a virtual private network (VPN).

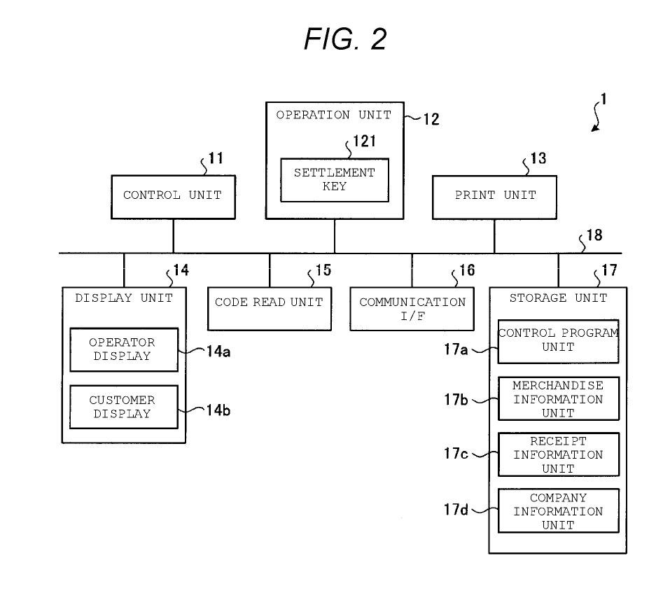

The POS terminal 1 performs sales registration processing and settlement processing of merchandise to be sold in stores. The sales registration processing refers to a process for displaying merchandise information such as a merchandise name and price of merchandise to be sold to customers, and for storing the information in a merchandise information unit 17b, based on a merchandise code obtained (see FIG. 2). The settlement processing refers to a process for displaying settlement information such as the total amount of money related to transaction of customers, a deposit amount deposited from customers, and change amount, based on the merchandise information of the merchandise on which the sales registration processing is performed. The POS terminal 1 outputs a paper receipt by printing receipt information including the merchandise information of the merchandise on which the sales registration processing is performed and the settlement information in a print unit 13, which will be described below. In addition, the POS terminal 1 transmits the electronic receipt information in which a data format of receipt information is converted and transmitted to the electronic receipt server 3 through the network N2, instead of printing the receipt information. When the electronic receipt information is output to the electronic receipt server 3, the POS terminal 1 transmits the electronic receipt information obtained by including a membership code for specifying the customer who became a member, a store identification (ID) for specifying the store, and a company ID for specifying a company operating the store in the electronic receipt information.

The store server 2 integrally performs management of the merchandise information related to the sales registration processing and the settlement information related to the settlement processing performed in the POS terminal 1.

The number of the POS terminals 1 disposed at the store P1 is not particularly limited, and may be plural. In addition, in the embodiment, a configuration in which the POS terminal 1 outputs the electronic receipt information is described. However, the embodiment is not limited thereto, and a configuration in which a data format of the electronic receipt information generated from the POS terminal 1 is converted by using the store server 2 or a conversion device (not illustrated) such that the electronic receipt information is output to the electronic receipt server 3 may be implemented.

The electronic receipt server 3 is provided in the headquarters P3 of the company operating the store (or a chain store) (hereinafter, referred to as store). The electronic receipt server 3 functions as a company receipt management server for managing the electronic receipt information of the company operating the store. For example, the electronic receipt server 3 has functions of sales management, sales analysis, inventory management, or the like of the company operating the store.

In addition, the electronic receipt server 3 receives the electronic receipt information transmitted from the POS terminal 1 through the network N2. In addition, the electronic receipt server 3 transmits the received electronic receipt information to the electronic receipt management server 4, through a network N3 connecting the headquarters P3 and an electronic receipt center P4. The electronic receipt server 3 transmits the electronic receipt information including the store ID and the company ID to the electronic receipt management server 4.

Here, the network N3 is the leased line such as the Internet and VPN. In addition, a transmission method of the electronic receipt information is not particularly limited, and may use a general protocol such as HTTP and HTTPS.

The electronic receipt management server 4 is provided in the electronic receipt center P4. For example, the electronic receipt center P4 is a third party other than the company managing the receipt information in the electronic receipt server 3. The third party or the like may also manage the electronic receipt server 3.

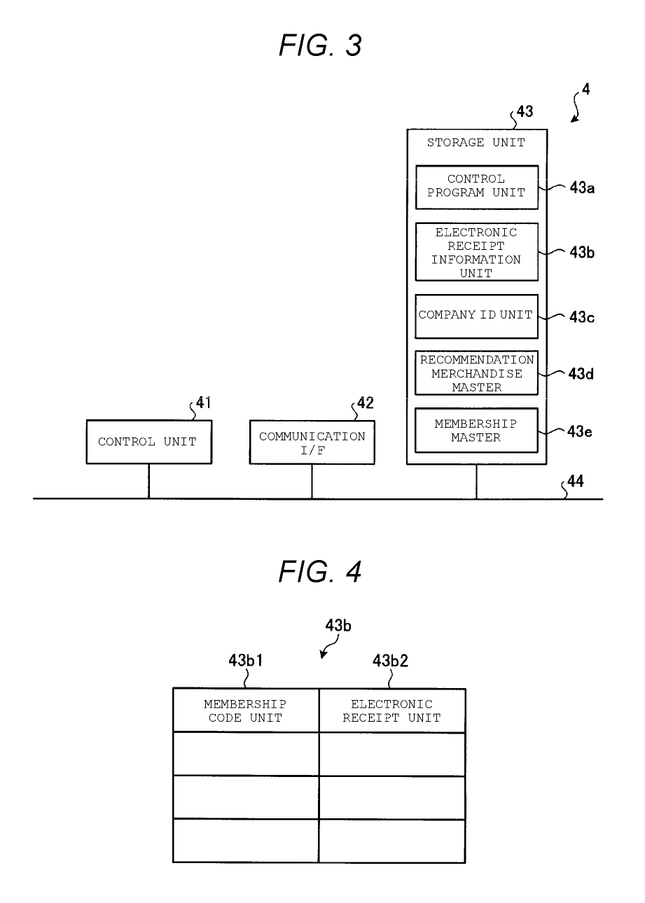

The electronic receipt management server 4 functions as a customer receipt management server that collectively manages the receipt information of various companies operating the store. The electronic receipt management server 4 stores and manages membership data such as a name and the membership code of each customer (member) on whom membership registration is performed, and reception destination information (for example, e-mail address) of the portable terminal 7 (display device) to be a reception destination of the electronic receipt information in a membership master 43e (see FIG. 3).

In addition, the electronic receipt management server 4 receives the electronic receipt information transmitted from the electronic receipt server 3 through the network N3, and stores and manages the electronic receipt information in an electronic receipt information unit 43b (see FIG. 3). More specifically, the electronic receipt information stored in the electronic receipt information unit 43b includes the membership code, the store ID, the company ID, an issue date, or the like in addition to the merchandise information and the settlement information of the merchandise, and is stored and managed per a membership code of a corresponding member.

In addition, the electronic receipt management server 4 specifies the reception destination (portable terminal 7) by referring to the reception destination information stored in the membership master 43e in correlation with the membership code of the electronic receipt information. Accordingly, when the electronic receipt management server 4 receives a browse request of an electronic receipt in which a membership code is specified from the portable terminal 7 connected through the network N5, which will be described below, the electronic receipt information corresponding to the membership code can be browsed on the portable terminal 7.

The portable terminal 7 is a terminal device such as a smartphone, a mobile phone, a personal digital assistant (PDA), and a tablet type computer, used by a user of the system. The portable terminal 7 implements an application such as a Web browser for browsing various types of information provided on the network N5 therein. The terminal device such as a PC other than the portable terminal 7 may be applied as the display device. In addition, there is the customer of the store, an owner or a holder of the portable terminal 7, or the like as a user of this system.

The portable terminal 7 performs the membership registration for this system by accessing the electronic receipt management server 4 through the network N5. Here, the network N5 is various public networks or the Internet.

A customer inputs requirements to the portable terminal such that the membership registration through which a customer becomes a member is performed. The electronic receipt management server 4 performs the membership registration with respect to a membership master, and transmits a membership registration completion mail including the membership code and a password to the portable terminal 7.

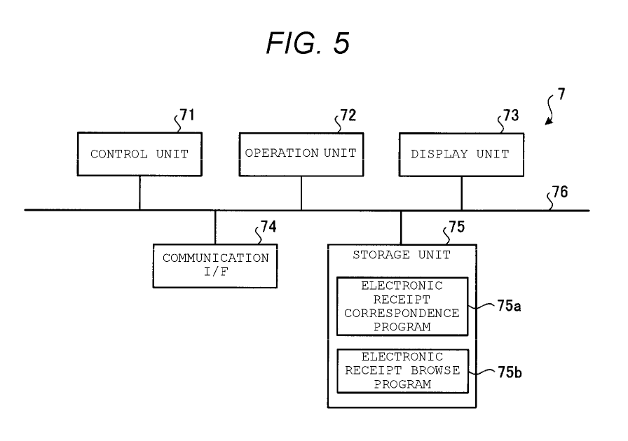

The portable terminal 7 in which the membership registration is performed displays the membership code of a member as a code symbol such as a bar code and a two-dimensional code on a display unit 73 (see FIG. 5). The member presents the code symbol displayed on the portable terminal 7 to a salesperson when transaction that merchandise is purchased starts in the store P1. The salesperson reads the code symbol displayed on the portable terminal 7 by using the code read unit 15 (see FIG. 2), configured by, for example, a scanner connected to the POS terminal 1. The POS terminal 1 analyzes the read code symbol, and obtains the membership code. With this, it is possible to correlate the membership code of a customer with the receipt information generated in the settlement processing in the POS terminal 1.

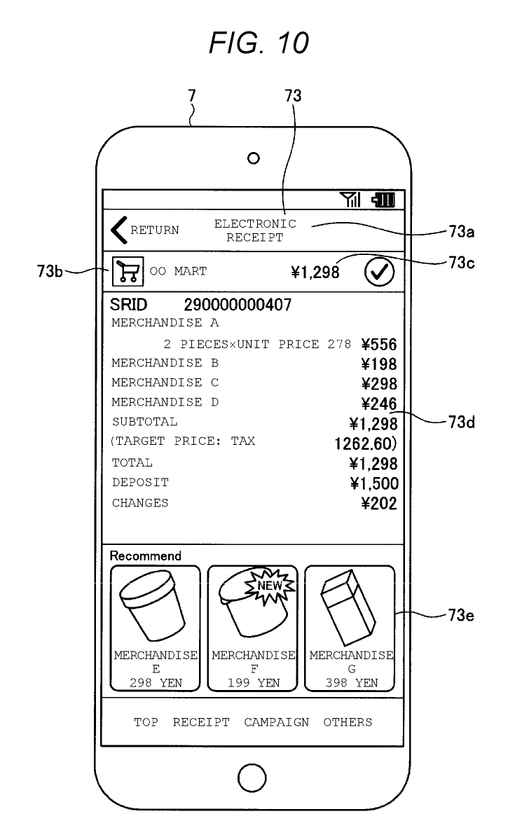

In addition, the portable terminal 7 receives the electronic receipt information transmitted from the electronic receipt management server 4 through the network N5. In addition, the portable terminal 7 displays the received electronic receipt information on the display unit 73 (see FIG. 5), which will be described below (see FIG. 10).

In the electronic receipt system of such a configuration, the electronic receipt information generated in the POS terminal 1 is transmitted to the electronic receipt management server 4 via the electronic receipt server 3. The portable terminal 7 in which the Web browser is installed designates a uniform resource locator (URL), and downloads the receipt information published on the Web by the electronic receipt management server 4 to the portable terminal 7 such that the downloaded receipt information can be browsed on the Web browser. An application for browsing the receipt information may be installed in the portable terminal 7 to browse the downloaded receipt information. In addition, in the embodiment, the electronic receipt information is transmitted from the POS terminal 1 to the electronic receipt management server 4 via the electronic receipt server 3. However, the electronic receipt information may be directly transmitted from the POS terminal 1 to the electronic receipt management server 4.

The recommendation server 8 and the member server 9 are provided in a management company P5. The recommendation server 8 generates recommendation information that is information for specifying recommendation merchandise with respect to a customer according to a request from the electronic receipt management server 4.

The recommendation information is information of the recommendation merchandise extracted by the recommendation server 8 based on the merchandise information and the membership code included in the electronic receipt information. The recommendation information includes the merchandise code for specifying the recommendation merchandise. Among merchandise to be sold in the store and handled in the store, the recommendation merchandise refers to merchandise obtained in connection with merchandise (purchase information) purchased by a customer in the past or current shopping and matched with the merchandise purchased by the customer in the past or current shopping, merchandise that the store recommends to the customer, or merchandise that the store wants to sell to the customer. The recommendation merchandise may be merchandise that is purchased by the customer in the past, or not purchased by the customer in the past. In addition, the recommendation merchandise may be merchandise related to the merchandise information included in the electronic receipt information, and may be merchandise not related to the merchandise information included in the electronic receipt information.

The recommendation server 8 extracts information for specifying the recommendation merchandise for the customer according to a predetermined algorithm based on a customer purchase history per a member stored in the member server 9 and the merchandise information included in the electronic receipt information transmitted from the electronic receipt management server 4, and generates the recommendation information. Specifically, the recommendation server 8 extracts a candidate of the recommendation merchandise for the customer, based on a past purchase history (past purchase information of customer) of the customer. At that time, the recommendation server 8 extracts the candidate by considering recommend merchandise of the store, seasonal merchandise, trend merchandise, or the like. Next, the recommendation server 8 narrows a range of candidate merchandise related to received purchase merchandise information (current purchase information) of the customer from the extracted candidate merchandise. Furthermore, the recommendation server 8 extracts three items of the recommendation merchandise that are higher three recommendation degrees from the candidate merchandise of which the range is narrowed. Accordingly, the recommendation server 8 generates the recommendation information related to the narrowed recommendation merchandise. The recommendation server 8 transmits the recommendation information generated as described above to the electronic receipt management server 4.

The electronic receipt management server 4 to which the recommendation information is received obtains recommendation merchandise information of the recommendation merchandise based on the recommendation information, and generates association electronic receipt information integrated with the electronic receipt information. In addition, the electronic receipt management server 4 enables the generated association electronic receipt information to be browsed on the portable terminal 7.

Next, a configuration of a main device for constructing the electronic receipt system of the embodiment will be described. First, the POS terminal 1 that is a merchandise sales data processing device will be described. FIG. 2 is a block diagram illustrating a hardware configuration of the POS terminal 1. As illustrated in FIG. 2, the POS terminal 1 includes a control unit 11 that integrally controls various operations and each unit of the POS terminal 1. The control unit 11 includes a central processing unit (CPU), a read only memory (ROM), a random access memory (RAM), and the like. The ROM stores various programs and data. The RAM temporarily stores various programs or stores various types of data in a rewritable manner.

The control unit 11 is connected to an operation unit 12, the print unit 13, a display unit 14, a code read unit 15, a communication interface (I/F) 16, and a storage unit 17 through a bus 18.

The operation unit 12 includes various operation keys for performing an input operation by an operator. For example, as operation keys, numeric keys for inputting numeric values, cursor keys and selection decision keys for selecting a predetermined item, a settlement key 121 operated when a transaction with the customer is completed by performing a single transaction and settling the payment, and the like are provided.

The print unit 13 is configured by a printer device for performing printing on a roll sheet such as a receipt and journal. The print unit 13 includes a cut mechanism for cutting the sheet.

The display unit 14 is a liquid crystal display or the like, and displays the various types of information such as an item name and price of merchandise on which sales registration is performed, the total amount of money of a single transaction in which settlement is declared, and a change amount. The display unit 14 includes an operator display 14a that displays the various types of information for a cashier, and a customer display 14b that displays the various types of information for customers.

The code read unit 15 is a scanner device that optically reads the code symbol such as the bar code and the two-dimensional code. For example, the code read unit 15 reads the code symbol attached to merchandise, the code symbol displayed on the portable terminal 7, or the like. The control unit 11 analyzes the read code symbol, and obtains a code included in the code symbol. In the code symbol attached to merchandise, the merchandise code for specifying the merchandise thereof or the like is included. In addition, in the code symbol displayed on the portable terminal 7, the membership code for specifying a customer holding the portable terminal 7 thereof is included. The membership code may be magnetically or electrically stored in the portable terminal 7. In this case, a dedicated reader reads the stored membership code. The control unit 11 inputs the read membership code.

In addition, the control unit 11 can be connected to the network N1 or the network N2 within a store through a communication I/F 16.

The storage unit 17 is an auxiliary storage device such as a hard disk drive (HDD) and a solid state drive (SSD). The storage unit 17 includes a control program unit 17a that stores a control program for executing various types of POS work including merchandise sales data processing. In addition, the storage unit 17 includes a merchandise information unit 17b that stores the merchandise information of the merchandise on which the sales registration processing is performed. In addition, the storage unit 17 includes a receipt information unit 17c that stores the receipt information of the merchandise on which the sales registration processing is performed. The control program unit 17a also stores a conversion rule for converting receipt information of an unstructured format into receipt information (hereinafter, which will be referred to as electronic receipt information) of a structured format.

In addition, the storage unit 17 includes a company information unit 17d that stores a POS number for distinguishing a self POS terminal 1 from other POS terminals 1, the store ID for specifying the store P1, and the company ID for specifying the company operating the store. The company ID may be registered in the electronic receipt server 3.

Next, a configuration (not illustrated) of the electronic receipt server 3 that functions as the company receipt management server will be described. The electronic receipt server 3 includes a control unit that integrally controls various operations or each unit of the electronic receipt server 3. The control unit includes a CPU, a ROM for storing various programs and data, a RAM temporarily for storing various programs or storing various types of data in a rewritable manner, and the like.

The control unit can be connected to the network N2 or the network N3 through the communication I/F connected to the bus. In addition, the control unit is connected to a storage unit through the bus. The storage unit stores the electronic receipt information for each of the company operating the store, which is transmitted from the POS terminal 1. In addition, the storage unit manages the electronic receipt information, and stores a control program for transmitting the receipt information to the electronic receipt management server 4.

Next, a configuration of the electronic receipt management server 4 that functions as the customer receipt management server will be described by using a block diagram of FIG. 3. As illustrated in FIG. 3, the electronic receipt management server 4 includes a control unit 41 that integrally controls various operations and each unit of the electronic receipt management server 4. The control unit 41 includes a CPU, a ROM for storing various programs and data, a RAM temporarily for storing various programs or storing various types of data in a rewritable manner, and the like.

The control unit 41 is connected to a communication I/F 42 and a storage unit 43 through a bus 44. The control unit 41 can be connected to the network N3 and the network N5 through the communication I/F 42.

The storage unit 43 includes a control program unit 43a, the electronic receipt information unit 43b, a company ID unit 43c, a recommendation merchandise master 43d, and the membership master 43e. The control program unit 43a stores a control program for integrally controlling the electronic receipt management server 4. The electronic receipt information unit 43b stores the electronic receipt information transmitted from the electronic receipt server 3. The company ID unit 43c stores the company ID in which the electronic receipt information and the recommendation merchandise information corresponding to the recommendation information are integrated (associated) with each other. That is, whether or not the recommendation information is requested to the electronic receipt information is different from company to company. Therefore, the company ID of a company that requests the recommendation information with respect to the recommendation server 8 is stored in the company ID unit 43c. The company ID is included in the electronic receipt information. Therefore, the electronic receipt management server 4 investigates the company ID unit 43c based on the electronic receipt information received from the electronic receipt server 3, and determines whether or not there is a company requesting recommendation. The recommendation merchandise master 43d stores the recommendation merchandise information (image or the like of merchandise in addition to merchandise information (merchandise name and price)) of the merchandise, URL information of a linked site, or the like corresponding to the merchandise code of the merchandise included in the recommendation information received from the recommendation server 8.

Next, the electronic receipt information unit 43b will be described. FIG. 4 is a memory map illustrating the electronic receipt information unit 43b. The electronic receipt information unit 43b stores the electronic receipt information received from the POS terminal 1 per membership code. The electronic receipt information unit 43b includes a membership code unit 43b1 and an electronic receipt unit 43b2. The membership code unit 43b1 stores the membership code. The electronic receipt unit 43b2 stores the electronic receipt information of a member specified by the membership code. There is also a case where the electronic receipt unit 43b2 stores the association electronic receipt information, which will be described below, instead of the electronic receipt information.

Next, a configuration of the portable terminal 7 will be described. FIG. 5 is a block diagram illustrating a hardware configuration of the portable terminal. As illustrated in FIG. 5, the portable terminal 7 includes a control unit 71 that integrally controls various operations and each unit of the portable terminal 7. The control unit 71 includes a CPU, a ROM for storing various programs and data, a RAM temporarily for storing various programs or storing various types of data in a rewritable manner, and the like.

The control unit 71 is connected to an operation unit 72, the display unit 73, a communication I/F 74, and a storage unit 75 through a bus 76. The operation unit 72 includes various types of operation keys and a pointing device for performing an input operation by the customer. The display unit 73 is the liquid crystal display or the like, and displays the various types of information such as the electronic receipt information which will be described below. The display unit 73 may be implemented as a touch panel configuration, and, in this case, the touch panel functions as the operation unit 72. The control unit 71 can be connected to the network N5 through the communication I/F 74.

The storage unit 75 stores an electronic receipt correspondence program 75a for receiving the electronic receipt information from the electronic receipt management server 4 and an electronic receipt display program 75b for browsing the received receipt information, in addition to the Web browser for browsing the various types of information (content) published on the Web.

From here, a control process of each unit constituting a system of the embodiment will be described. First, the control process performed by controlling the control unit 11 of the POS terminal 1 according to a control program stored in the control program unit 17a will be described.

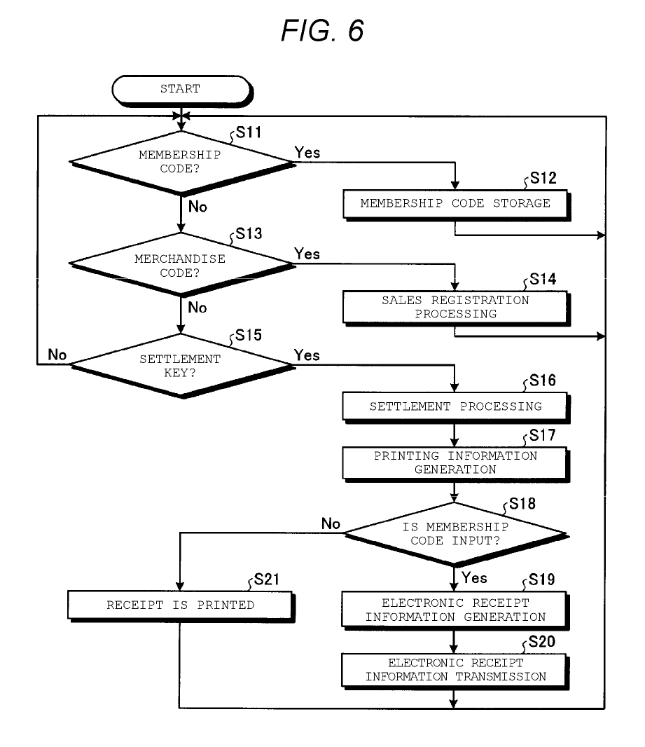

FIG. 6 is a flowchart illustrating the control process of the POS terminal. As illustrated in FIG. 6, the control unit 11 of the POS terminal 1 determines whether or not the membership code included in the code symbol read by the code read unit 15 is obtained (S11). When it is determined that the membership code is obtained (Yes of S11), the control unit 11 stores the membership code in the storage unit 17 (S12). Then, the control unit 11 returns to S11.

In addition, when it is determined that an input of the membership code is not obtained (No of S11), the control unit 11 determines whether or not the merchandise code included in the code symbol obtained by the code read unit 15 is obtained (S13). When it is determined that the merchandise code is obtained (Yes of S13), the control unit 11 reads the merchandise code related to the merchandise information of the merchandise, and stores the read merchandise code in the merchandise information unit 17b (S14). Then, the control unit 11 returns to S11.

In addition, when it is determined that the merchandise code is not obtained (No of S13), the control unit 11 determines whether or not the settlement key 121 is operated (S15). When it is determined that the settlement key 121 is operated (Yes of S15), the control unit 11 performs the settlement processing of the transaction, based on the merchandise information stored in the merchandise information unit 17b (S16). Accordingly, the control unit 11 generates the receipt information of unstructured format data related to the transaction based on the merchandise information and the settlement information on which the settlement processing is performed (S17). Accordingly, the control unit 11 stores the generated receipt information in the receipt information unit 17c. Next, the control unit 11 determines whether or not the membership code is obtained in S11 (S18). When it is determined that the membership code is obtained (Yes of S18), the control unit 11 generates the electronic receipt information obtained by converting the receipt information stored in the receipt information unit 17c into structured format data (S19). At that time, the control unit 11 includes the membership code, the store ID, and the company ID in the electronic receipt information. Accordingly, the control unit 11 transmits the generated electronic receipt information to the electronic receipt server 3 (S20). Then, the control unit 11 returns to S11. The electronic receipt server 3 to which the electronic receipt information is received transmits the electronic receipt information to the electronic receipt management server 4.

Meanwhile, when it is determined that the membership code is not obtained (No of S18), the control unit 11 drives the print unit 13, and issues a receipt on which the receipt information stored in the receipt information unit 17c is printed (S21). Then, the control unit 11 returns to S11. When it is determined that the settlement key 121 is not operated (No of S15), the control unit 11 returns to S11.

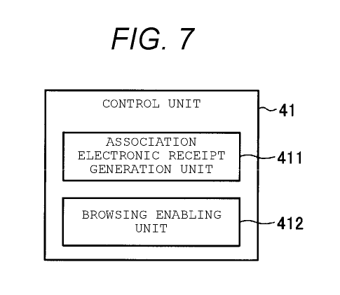

Next, control of the electronic receipt management server 4 will be described. FIG. 7 is a functional block diagram illustrating a functional configuration of the electronic receipt management server 4. The control unit 41 includes functions of an electronic receipt generation unit 411 and a browsing enabling unit 412 according to a control program stored in the ROM and the control program unit 43a of the storage unit 43.

The association electronic receipt generation unit 411 has a function of generating the association electronic receipt information in which the electronic receipt information related to the merchandise purchased by a customer and the recommendation merchandise information obtained in connection with purchase information of the customer are associated with each other. The browsing enabling unit 412 has a function of enabling the association electronic receipt information generated by the association electronic receipt generation unit 411 to be browsed on the portable terminal 7.

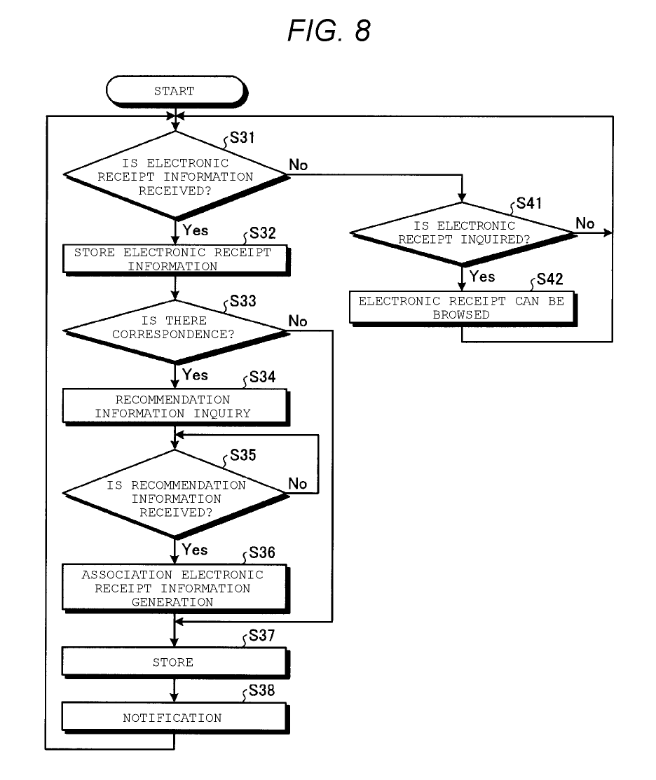

FIG. 8 is a flowchart illustrating a control process of the electronic receipt management server. As illustrated in FIG. 8, the control unit 41 determines whether or not the electronic receipt information is received from the electronic receipt server 3 (S31). When it is determined that the electronic receipt information is received (Yes of S31), the control unit 41 stores the electronic receipt information in the electronic receipt unit 43b2 of the electronic receipt information unit 43b per the membership code included in the electronic receipt information (S32). Next, the control unit 41 determines whether or not the company ID included in the stored electronic receipt information corresponds to a company requesting the recommendation information (S33). When the company ID is stored in the company ID unit 43c, it is determined that the company ID included in the electronic receipt information corresponds to the company requesting the recommendation information.

When it is determined that the company ID corresponds to the company requesting the recommendation information (Yes of S33), the control unit 41 attaches the electronic receipt information including the merchandise information (current purchase information) of merchandise purchased in current shopping, and inquires about the recommendation information, from the recommendation server 8 (S34). Accordingly, the control unit 41 determines that the recommendation information is received (S35). The control unit waits until the recommendation information is received (No of S35). When it is determined that the recommendation information is received (Yes of S35), the control unit 41 obtains the recommendation merchandise information based on the received recommendation information. Specifically, the control unit 41 reads (obtains) corresponding recommendation merchandise information from the recommendation merchandise master 43d based on the merchandise code of the recommendation merchandise included in the received recommendation information. The read recommendation merchandise information includes the merchandise name and price, an image of merchandise, or the like. Next, the control unit 41 (in particular the association electronic receipt generation unit 411) generates the association electronic receipt information in which the read recommendation merchandise information is integrated with the electronic receipt information inquired about in S34 (S36). The integration means that the electronic receipt information and the recommendation merchandise information are combined with each other such that one new electronic receipt information is generated as the association electronic receipt information. The association electronic receipt information includes a URL of a site (for example, maker) that introduces information of the recommendation merchandise.

Next, the control unit 41 stores the association electronic receipt information generated in S36 in the electronic receipt unit 43b2 (S37). At that time, original electronic receipt information is deleted. Accordingly, the control unit 41 transmits notification indicating that the electronic receipt information can be browsed to a customer in accordance with the membership code included in the electronic receipt information (S38). At that time, the control unit 41 transmits the notification to an address that is a reception destination of the portable terminal 7 of a member stored in the membership master 43e, and specified by the membership code. Then, the control unit 41 returns to S31.

In S33, when it is determined that the company ID does not correspond to the company requesting the recommendation information (No of S33), the control unit 41 performs S37 and subsequent steps without requesting the recommendation information with respect to the recommendation server 8.

In addition, in S31, when it is determined that the electronic receipt information is not received from the POS terminal 1 (No of S31), the control unit 41 determines whether or not browse request information of the electronic receipt is received from the portable terminal 7 (S41). When it is determined that the browse request information is received (Yes of S41), the control unit 41 (in particular, the browsing enabling unit 412) enables the electronic receipt information or the association electronic receipt information stored in the electronic receipt unit 43b2 to be browsed on the portable terminal 7 which transmits the display request information (S42). That is, the control unit 41 copies the electronic receipt information or the association electronic receipt information to a Web server (not illustrated). Accordingly, the control unit 41 transmits a browsable message including a copy destination URL of the Web server to which the information is copied to the portable terminal 7. Then, the control unit 41 returns to S31. When it is determined that the browse request information of the electronic receipt is not received (No of S41), the control unit 41 returns to S31.

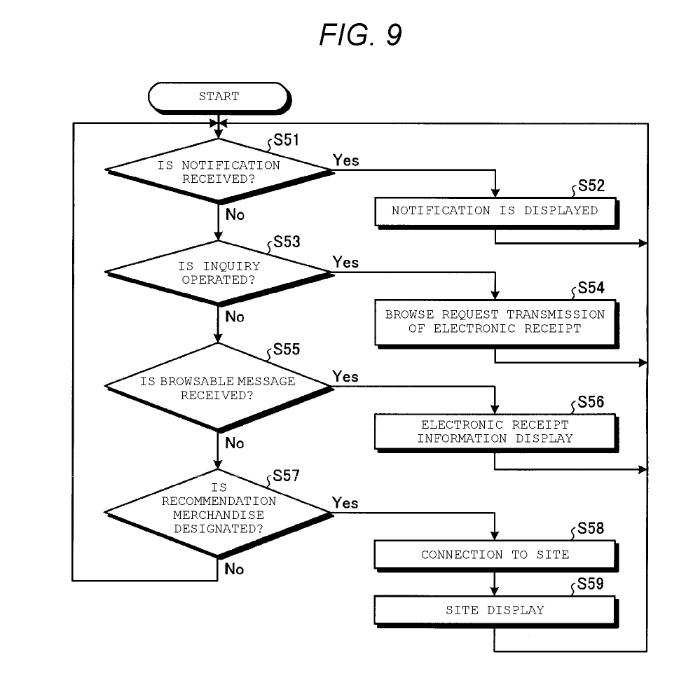

Next, control of the portable terminal 7 will be described. FIG. 9 is a flowchart illustrating the control process of the portable terminal 7. As illustrated in FIG. 9, the control unit 71 determines whether or not browsable notification of the electronic receipt is received from the electronic receipt management server 4 (S51). When it is determined that the browsable notification is received (Yes of S51), the control unit 71 displays the notification on the display unit 73 of the portable terminal 7 (S52). Then, the control unit 71 returns to S51. In addition, when it is determined that the browsable notification of the electronic receipt is not received (No of S51), the control unit 71 determines whether or not a user operates the browse request of the electronic receipt from the operation unit 72 (S53). When it is determined that the user operates the browse request (Yes of S53), the control unit 71 transmits the browse request of the electronic receipt to the electronic receipt management server 4 (S54). Then, the control unit 71 returns to S51.

In addition, when it is determined that the browse request of the electronic receipt is not operated (No of S53), the control unit 71 determines whether or not a browsable message including the URL of a display destination of the electronic receipt is received from the electronic receipt management server 4 (S55). When it is determined that the browsable message is received (Yes of S55), the control unit displays the electronic receipt or the association electronic receipt by accessing the URL (S56). The user browses the displayed electronic receipt or association electronic receipt. Then, the control unit 71 returns to S51.

FIG. 10 is a diagram illustrating a display example of the association electronic receipt displayed on the display unit 73 of the portable terminal 7 by the control unit 71 in S56. As illustrated in FIG. 10, the control unit 71 displays a title 73a indicating the association electronic receipt. The “electronic receipt” is displayed in an example of FIG. 10. In addition, the control unit 71 displays the name of a store or the name of a company 73b from which the association electronic receipt is issued. In addition, the control unit 71 displays a tax included purchase amount 73c of purchase merchandise recorded in the association electronic receipt. In addition, the control unit 71 displays detail merchandise information of the purchased merchandise recorded in the association electronic receipt and settlement information 73d. The displayed merchandise information is the merchandise name, price, or the like, and the displayed settlement information is the total amount of money, the deposit amount, the change amount, or the like.

In addition, the control unit 71 displays recommendation merchandise 73e for customer as a part of the association electronic receipt information. That is, in an example of FIG. 10, the control unit 71 displays merchandise E, merchandise F, and merchandise G, which are recommended to customers as recommendation merchandise 73e, on the same screen along with the electronic receipt information. The recommendation merchandise 73e is an image generated based on the merchandise name and price, the image of merchandise, or the like as the recommendation merchandise information read from the recommendation merchandise master 43d based on the recommendation information. The recommendation merchandise 73e and the electronic receipt information are displayed in parallel on the display unit 73 of the portable terminal 7 as the association electronic receipt information.

In addition, when it is determined that the browsable message is not received from the electronic receipt management server 4 (No of S55), the control unit 71 determines whether or not one of the recommendation merchandise 73e displayed on the display unit 73 is designated by a user (S57). In a case of FIG. 10, any one of the merchandise E, the merchandise F, and the merchandise G is designated. When it is determined that one is designated (Yes of S57), the control unit 71 is connected to a corresponding site by accessing a URL of a link destination site of the designated recommendation merchandise 73e, stored as the association electronic receipt information (S58). Accordingly, the control unit 71 displays browse information of the connected site (S59). Then, the control unit 71 returns to S51. When it is determined that any of the recommendation merchandise 73e is not designated (No of S57), the control unit 71 returns to S51.

According to the embodiment, the control unit 41 obtains the recommendation merchandise information based on the recommendation information received from the recommendation server 8 based on the electronic receipt information related to the merchandise purchased by a customer. The control unit 41 generates the association electronic receipt information in which the obtained recommendation merchandise information and the electronic receipt information are integrated with each other, and enables the association electronic receipt to be browsed on the portable terminal 7. Therefore, the customer can browse the electronic receipt information and the recommendation merchandise for the customer displayed on the portable terminal 7.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

For example, in the embodiment, the recommendation merchandise information is obtained from the recommendation merchandise master 43d based on the merchandise code included in the recommendation information received from the recommendation server 8, and thereby integrated with the electronic receipt. However, the recommendation server 8 obtains the recommendation merchandise information, and the obtained recommendation merchandise information is received such that the received recommendation merchandise information may be integrated with the electronic receipt.

In addition, in the embodiment, the association electronic receipt information in which the electronic receipt information and the recommendation merchandise information are integrated with each other is described. However, the association electronic receipt information may not integrate the electronic receipt information and the recommendation merchandise information. For example, the association electronic receipt information in which the electronic receipt information and the recommendation merchandise information are associated with each other, an association result is stored, and both items of the information are displayed in parallel on the portable terminal 7 may be implemented.

In addition, in the embodiment, the recommendation information is generated based on the past purchase history of a customer and current purchase merchandise information of the customer. However, the recommendation information may be generated based on one of the past purchase history of the customer and the current purchase merchandise information of the customer.

In addition, in the embodiment, the recommendation server 8 is provided in the management company P5 of an outside of the electronic receipt center P4. However, the recommendation server 8 may be provided in the electronic receipt center P4. In addition, the electronic receipt management server 4 may have a function of the recommendation server 8.

A program executed in the electronic receipt management server 4 of the embodiment is provided by being recorded in a readable recording medium in a computer in an installable format or an executable format file such as a CD-ROM, a flexible disk (FD), a CD-R, and a digital versatile disk (DVD).

In addition, the program executed in the electronic receipt management server 4 of the embodiment may be configured to store on a computer connected to a network such as the Internet, and to provide by being downloaded via the network. In addition, the program executed in the electronic receipt management server 4 of the embodiment may be configured to provide or distribute via the network such as the Internet.

In addition, the program executed in the electronic receipt management server 4 of the embodiment may be configured to provide by incorporating in advance in the ROM or the like.

What is claimed is:

1. A distributed information processing system, comprising:
a plurality of point-of-sale (POS) terminals configured to collect data;
a first server communicating with the POS terminals over a private network to aggregate data collected by the POS terminals;
a second server communicating with the first server over a public network to centrally store the aggregated data from the first server and other servers that aggregate data collected by POS terminals;
a third server communicating with the second server over the public network to generate specialized content based on data stored by the second server; and
a portable terminal of a user registered with the second server, wherein the portable terminal is configured to simultaneously display on a display unit thereof a first image representative of a piece of data stored by the second server for the user and a second image representative of the specialized content generated by the third server based on data stored by the second server for the user.

2. The system according to claim 1, wherein the POS terminals generate electronic receipts in response to purchases made by different users registered with the second server, and the second server stores the electronic receipts in association with member IDs of the registered users upon receipt of the electronics receipts from the first server and other servers that aggregate electronic receipts generated by the POS terminals.

3. The system according to claim 2, wherein the third server determines that a request for specialized content has been made by the first server or one of the other servers prior to generating the specialized content.

4. The system according to claim 1, wherein the specialized content is a product recommendation.

5. The system according to claim 4, wherein the portable terminal displays the second image in a user-selectable region of a graphical user interface such that, when the region is selected by the user, a URL associated with the specialized content is accessed.

6. A method of processing information in a distributed information processing system that includes a plurality of point-of-sale (POS) terminals configured to collect data, a first server communicating with the POS terminals over a private network to aggregate data collected by the POS terminals, a second server communicating with the first server over a public network to centrally store the aggregated data from the first server and other servers that aggregate data collected by POS terminals, a third server communicating with the second server over the public network, and a portable terminal of a user registered with the second server, said method comprising:
at the third server, generating specialized content based on data stored by the second server; and
at the portable terminal, simultaneously displaying on a display unit thereof a first image representative of a piece of data stored by the second server for the user and a second image representative of the specialized content generated by the third server based on data stored by the second server for the user.

7. The method according to claim 6, further comprising:
at the POS terminals, generating electronic receipts in response to purchases made by different users registered with the second server; and
at the second server, storing the electronic receipts in association with member IDs of the registered users upon receipt of the electronics receipts from the first server and other servers that aggregate electronic receipts generated by the POS terminals.

8. The method according to claim 7, further comprising:
at the third server, determining that a request for specialized content has been made by the first server or one of the other servers prior to generating the specialized content.

9. The method according to claim 6, wherein the specialized content is a product recommendation.

10. The method according to claim 9, wherein the portable terminal displays the second image in a user-selectable region of a graphical user interface such that, when the region is selected by the user, a URL associated with the specialized content is accessed.
